(19) United States
(12) Patent Application Publication
(10) Pub. No.: US 2025/0236281 A1
(43) Pub. Date: Jul. 24, 2025

(54) CONTROLLER

(71) Applicant: DENSO CORPORATION, Kariya-city (JP)

(72) Inventors: Shigeru KAMIO, Kariya-city (JP); Taro HIRAI, Kariya-city (JP)

(21) Appl. No.: 18/986,231

(22) Filed: Dec. 18, 2024

Related U.S. Application Data
(63) Continuation of application No. PCT/JP2023/019471, filed on May 25, 2023.

(30) Foreign Application Priority Data
Jun. 24, 2022 (JP) 2022-101838

(51) Int. Cl. B60W 20/15; B60W 10/08; B60W 20/50

(52) U.S. Cl. CPC B60W 20/15; B60W 10/08; B60W 20/50; B60W 2510/0657; B60W 2510/083

(57) ABSTRACT

A controller is applied to a moving object using a rotary electric machine. The controller calculates demanded torque of the rotary electric machine based on operation information indicating the operation status. It calculates command torque of the rotary electric machine by performing a first gradual change process on the demanded torque to limit a change in the demanded torque. Torque control of the rotary electric machine is then performed. The controller includes a monitoring torque calculator that calculates monitoring torque based on the operation information. A monitoring gradual change processor performs a second gradual change process on the monitoring torque. A monitoring unit compares the command torque with the monitoring torque after performing the second gradual change process. The monitoring unit monitors the torque control of the rotary electric machine based on the result of the comparison.

### CROSS REFERENCE TO RELATED APPLICATIONS

The present application is a continuation application of International Patent Application No. PCT/JP2023/019471 filed on May 25, 2023, which designated the U.S. and claims the benefit of priority from Japanese Patent Application No. 2022-101838 filed on Jun. 24, 2022. The entire disclosures of all of the above applications are incorporated herein by reference.

### TECHNICAL FIELD

The present disclosure relates to a controller.

### BACKGROUND

An electronic control unit includes a microcomputer that controls an actuator and a monitoring unit that monitors occurrence of an abnormality in the microcomputer.

### SUMMARY

According to at least one embodiment, a controller is applied to a moving object that is movable using a rotary electric machine as a power source. The controller calculates demanded torque of the rotary electric machine based on operation information indicating the operation status of the moving object. It calculates command torque of the rotary electric machine by performing a first gradual change process on the demanded torque to limit a change in the demanded torque. Torque control of the rotary electric machine is then performed. The controller includes a monitoring torque calculator that calculates monitoring torque of the rotary electric machine based on the operation information. A monitoring gradual change processor performs a second gradual change process, which is different from the first gradual change process, on the monitoring torque. A monitoring unit compares the command torque of the rotary electric machine with the monitoring torque after performing the second gradual change process. The monitoring unit monitors the torque control of the rotary electric machine based on the result of the comparison.

### BRIEF DESCRIPTION OF DRAWINGS

The details of one or more embodiments are set forth in the accompanying drawings and the description below. Other features and advantages will be apparent from the description and drawings, and from the claims.

In the drawings:

FIG. 1 is a schematic diagram of a hybrid vehicle;

FIG. 2 is a functional block diagram illustrating processes of an engine controller and a rotary-electric machine controller;

FIG. 3 is a time chart illustrating an example of a low-pass filter process;

FIG. 4 is a time chart illustrating an example of a change rate limitation process;

FIG. 5 is a flowchart illustrating a procedure of torque control;

FIG. 6 is a time chart illustrating an example of the torque control;

FIG. 7 is a flowchart illustrating torque monitoring control;

FIG. 8 is a flowchart illustrating a procedure of a second gradual change process;

FIG. 9 is a flowchart of a process for determining reliability of estimated engine torque;

FIG. 10 is a flowchart of a process for determining validity of an engine torque correction value; and

FIG. 11 is a flowchart illustrating abnormality determination control.

### DETAILED DESCRIPTION

To begin with, examples of relevant techniques will be described.

An electronic control unit according to a comparative example includes a microcomputer that controls an actuator and a monitoring unit that monitors occurrence of an abnormality in the microcomputer. The electronic control unit performs a fail-safe action on the actuator in response to an abnormality within the microcontroller.

For example, in an electric vehicle that uses a rotary electric machine as its power source, demanded torque of the rotary electric machine is calculated based on vehicle's operation information, and torque control of the rotary electric machine is performed based on the demanded torque. In this case, a gradual change process such as annealing is performed on the demanded torque, and output torque of the rotary electric machine is controlled by the demanded torque after the gradual change process. Thus, occurrence of a torque shock can be reduced during transient periods when vehicle operating conditions change.

Another possible technology for monitoring vehicle torque control is to calculate monitoring torque based on vehicle operation information as well as the demanded torque, and to judge suitability of the demanded torque (demanded torque after gradual change processing) based on comparison result between the demanded torque and the monitoring torque. In this case, it is determined that an abnormality has occurred in the calculation process of the demanded torque of the rotary electric machine on a discrepancy between the demanded torque and the monitoring torque.

However, when the gradual change processing is performed on the demanded torque of the rotary electric machine as described above, there is concern that the discrepancy between the demanded torque and the monitoring torque may occur, and that an error may be judged to have occurred.

In contrast the comparative example, according to a controller, monitor torque can be properly controlled.

According to one aspect of the present disclosure, a controller is applied to a moving object that is movable using a rotary electric machine as a power source. The controller calculates demanded torque of the rotary electric machine based on operation information indicating the operation status of the moving object. It calculates command torque of the rotary electric machine by performing a first gradual change process on the demanded torque to limit a change in the demanded torque. Torque control of the rotary electric machine is then performed. The controller includes a monitoring torque calculator that calculates monitoring torque of the rotary electric machine based on the operation information. A monitoring gradual change processor performs a second gradual change process, which is different from the first gradual change process, on the monitoring torque. A monitoring unit compares the command torque of the rotary electric machine with the monitoring torque after performing the second gradual change process. The monitoring unit monitors the torque control of the rotary electric machine based on the result of the comparison.

According to this configuration, in a case of a moving object with a rotary electric machine as a power source, when torque control of the rotary electric machine is performed based on the operation information of the moving object, a gradual change process (first gradual change process) such as annealing is performed on the torque demanded of the rotary electric machine, and torque control of the rotary electric machine is performed using the command torque of the rotary electric machine after the gradual change process, thereby reducing torque shock during transients. This can be used to reduce torque shock during transient conditions. However, when torque monitoring is based on the rotary-electric-machine command torque, there is concern that the rotary-electric-machine command torque for monitoring may deviate even during normal conditions, resulting in a false determination of a torque control error.

Regarding this, the present disclosure performs the second gradual change process for the torque for monitoring, which is different from the first gradual change process for the torque for monitoring, and the torque for monitoring is monitored based on the results of the comparison between the torque for monitoring after the second gradual change process with the rotary-electric-machine command torque. As a result, the erroneous determination that torque control is abnormal under normal conditions can be reduced, and the rotary-electric-machine demanded torque can be properly monitored.

A first embodiment of a controller according to the present disclosure will be described below with reference to the drawings. The controller of the present embodiment is installed in a hybrid vehicle 10 equipped with an engine 11 and a rotary electric machine 13.

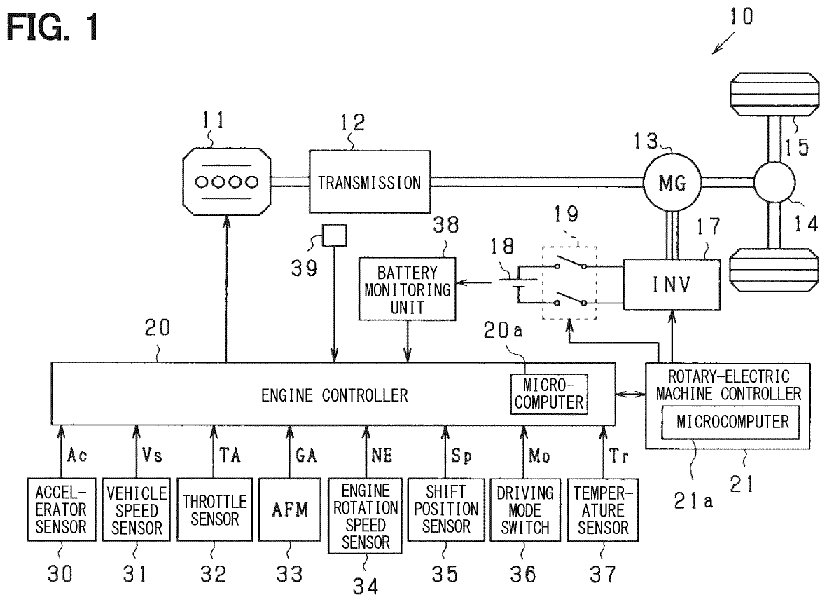

As shown in FIG. 1, the hybrid vehicle 10 has the engine 11, a transmission 12, the rotary electric machine 13, differential gears 14, and drive wheels 15. The engine 11 is, for example, a gasoline-fueled engine that generates driving power through combustion of fuel. An output shaft of the engine 11 is connected to an input shaft of the transmission 12. The transmission 12 is a continuously variable transmission (CVT) or a stepped automatic transmission (AT). The output shaft of the transmission 12 is connected to the drive wheels 15 via the rotary electric machine 13 and the differential gears 14. In other words, the engine 11 is one of a driving power source of the hybrid vehicle 10.

The rotary electric machine 13 has three-phase stator windings and a rotor, for example, a permanent magnet synchronous machine. The output shaft of the rotary electric machine 13 is connected to the drive wheels 15 via the differential gears 14. In other words, the rotary electric machine 13 is one of the driving power source of the hybrid vehicle 10.

The hybrid vehicle 10 is equipped with an inverter 17 and a storage battery 18. The inverter 17 is a 3-phase inverter with upper and lower arm switches. The switches on the upper and lower arms of each phase are electrically connected to the stator windings of each phase of the rotary electric machine 13. The inverter 17 is electrically connected to the storage battery 18 via a cutoff switch 19. The storage battery 18 is a battery suite consisting of multiple cells connected in series, for example, a secondary battery such as a lithium-ion or nickel-metal hydride storage battery. When the cutoff switch 19 is turned on, electric power can be supplied from the storage battery 18 to the inverter 17, and when the cutoff switch 19 is turned off, the electric power supply from the storage battery 18 to the inverter 17 is stopped. The cutoff switch 19 is, for example, a mechanical relay or a semiconductor switching device.

The hybrid vehicle 10 is equipped with an engine controller 20, a rotary-electric machine controller 21, and various sensors 30 to 36. An accelerator sensor 30 detects a pedal operation amount Ac, which is an amount of depressing an accelerator pedal as the driver's pedal control component. A vehicle speed sensor 31 detects vehicle speed Vs, which is traveling speed of the hybrid vehicle 10. A throttle sensor 32 detects a throttle opening degree TA of a throttle valve in an intake path of the engine 11. An air flow meter 33 detects intake air volume GA of the engine 11. An engine rotation speed sensor 34 detects rotation speed NE of a crankshaft of the engine 11.

A shift position sensor 35 detects a shift position Sp, which is a position of a shift lever of the transmission 12. The shift lever of the transmission 12 is operated by the driver. The shift position Sp of the present embodiment includes a parking range (P range) used to park the hybrid vehicle 10, a reverse range (R range) that directs the hybrid vehicle 10 to move backward, a neutral range (N range) where power transmission between the rotor and the drive wheels 15 is cut off, and a drive range (D range) that directs the hybrid vehicle 10 to move forward.

A driving mode switch 36 is used to set torque output characteristics of the rotary electric machine 13 and is operated by the driver. A driving mode of the hybrid vehicle 10 is set by operating the driving mode switch 36. In the present embodiment, the driving mode includes an economy mode, a normal mode and a sport mode. The economy mode is a mode that emphasizes energy efficiency in the hybrid vehicle 10, that is, electric cost rather than power output. The sport mode is a mode that emphasizes driving performance in the hybrid vehicle 10, that is, power output rather than power cost. The normal mode is an intermediate mode between the economy mode and the sport mode.

The hybrid vehicle 10 is equipped with a temperature sensor 37 for the rotary electric machine 13. The temperature sensor 37 detects temperature Tr of the rotary electric machine 13. The temperature of the rotary electric machine 13 is, for example, temperature of the stator windings in each phase. The detected values of each of the sensors 30 to 35, 37 and the driving mode signal Mo, which indicates the operating state of the driving mode switch 36, are input to the engine controller 20.

The hybrid vehicle 10 is equipped with a battery monitoring unit 38. The battery monitoring unit 38 detects an electric current flowing in the storage battery 18, a terminal voltage and temperature of each battery cell comprising the storage battery 18, and monitors a condition of the storage battery 18. In the present embodiment, the battery monitoring unit 38 is capable of communicating with the engine controller 20. The detected values of the battery monitoring unit 38 are input to the engine controller 20.

The hybrid vehicle 10 is equipped with a gear sensor 39 that detects a gear ratio (for example, gear stage of the shifting gear) by the transmission 12. The detected value of the gear sensor 39 is input to the engine controller 20.

Among the output signals of the sensors 30 to 39 that are input to the engine controller 20, the pedal operation amount Ac, the vehicle speed Vs, the throttle opening degree TA, the intake air volume GA, the rotation speed NE of the engine 11, the shift position Sp, and the gear ratio are redundant signals. The redundant signals are signals that are input to the engine controller 20 from sensors that are redundant, or from sensors to the engine controller 20 by means of redundant signal lines. On the other hand, the driving mode signal Mo, the detection value of the battery monitoring unit 38 and the temperature Tr of the rotary electric machine 13 are non-redundant signals. The non-redundant signals are signals that are input to the engine controller 20 from non-redundant sensors or from sensors to the engine controller 20 by a single signal line.

In the present embodiment, the sensor redundancy is realized, for example, in a configuration in which each of the sensing element, signal processing circuit, and output unit comprising the sensor is duplicated, or in a configuration in which a single sensing element is used and each of the signal processing circuit and output unit is duplicated. The redundant signal lines can be realized, for example, in a configuration where the sensor and the engine controller 20 are connected by two or more signal lines.

On the other hand, in the present embodiment, a non-redundant sensor is a sensor with a sensing element, a signal processing circuit, and an output unit. The non-redundant signal line are, for example, a situation in which the sensor and the engine controller 20 are connected by a single signal line. The redundant signals are more reliable signals and the non-redundant signals are less reliable than the redundant signals.

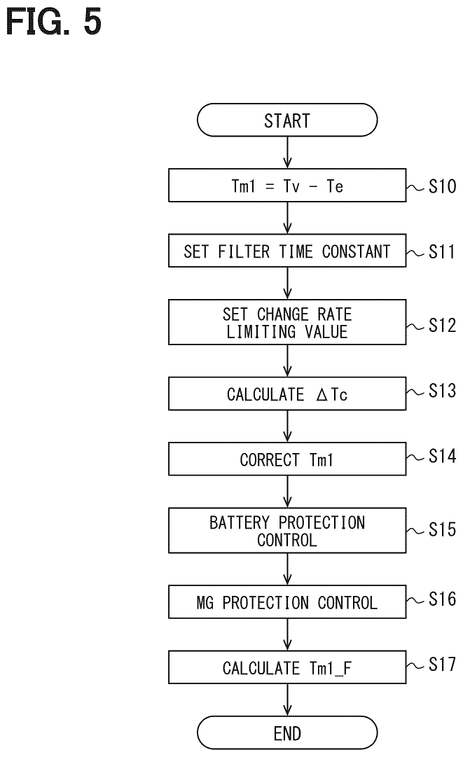

The engine controller 20 is mainly composed of a microcomputer 20a (equivalent to a “computer”), and the rotary-electric machine controller 21 is mainly composed of a microcomputer 21a (equivalent to a “computer”). In the present embodiment, the engine controller 20 is an upper controller among the respective controllers 20, 21. Each microcontroller 20a, 21a is equipped with a central processing device (i.e., CPU). Means and/or functions provided by each microcomputer 20a, 21a may be provided by software recorded in a substantive memory device and a computer that can execute the software, software only, hardware only, or some combination of them. For instance, suppose that each microcomputer 20a, 21a 61 be provided by including or using a hardware circuit serving as an electronic circuit. Such an electronic circuit may be provided by including analog circuitry and/or digital circuitry including multiple logic circuits. For example, each microcomputer 20a, 21a executes a program stored in a non-transitory tangible storage medium serving as a storage unit included therein. The program includes, for example, a program of processing shown in FIGS. 5, 7 to 11 and the like described later. With the execution of the program, a method corresponding to the program is executed. The storage unit is, for example, a non-volatile memory. The program stored in the storage unit may be updated via a network such as the Internet.

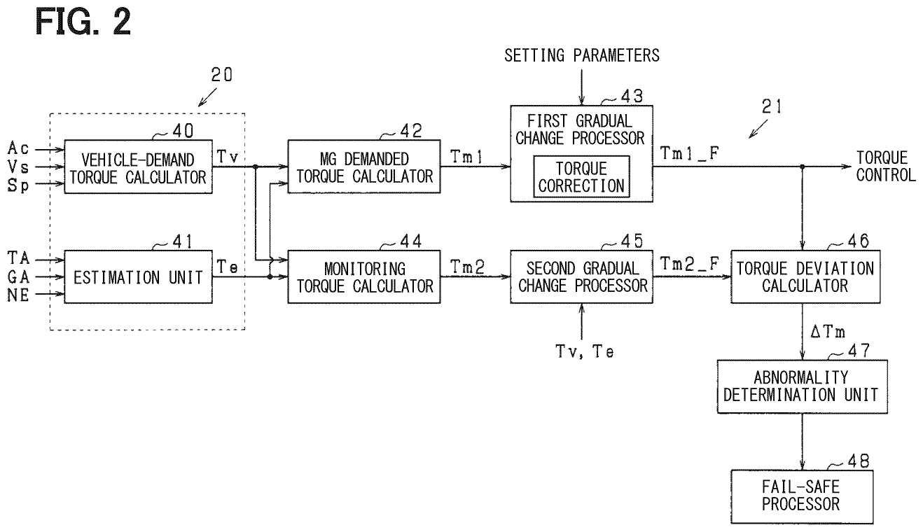

The rotary-electric machine controller 21 controls torque of the rotary electric machine 13. In the present embodiment, the rotary-electric machine controller 21 performs various controls in cooperation with the engine controller 20. More specifically, the engine controller 20 and the rotary-electric machine controller 21 are connected via communication lines such as a CAN bus to enable mutual communication, and various controls are performed while sending and receiving information between the respective controllers 20, 21. Hereinafter, control performed by the engine controller 20 and the rotary-electric machine controller 21 will be explained using FIG. 2. FIG. 2 shows the torque control of the rotary electric machine 13 and monitoring of the torque control.

The engine controller 20 has a vehicle-demand torque calculator 40 and an estimation unit 41. The vehicle-demand torque calculator 40 calculates vehicle demanded torque Tv based operation information indicating an operation status of the hybrid vehicle 10. The vehicle demanded torque Tv is torque demanded to be output to the drive wheels 15. The vehicle-demand torque calculator 40 outputs the calculated vehicle demanded torque Tv to the rotary-electric machine controller 21. In the present embodiment, the operation information is the amount of accelerator operation Ac, the vehicle speed Vs, and the shift position Sp.

The estimation unit 41 estimates engine torque Te based on engine information including engine load information. The estimation unit 41 is capable of estimating the engine torque Te using correspondence information (for example, map information or formula information) in which the engine torque Te and the operation information are corresponded in advance. The estimation unit 41 outputs the estimated engine torque Te to the rotary-electric machine controller 21. In the present embodiment, the engine information is the engine load information of the throttle opening degree TA and the intake air volume GA, and the rotation speed NE of the engine 11.

The engine controller 20 calculates the engine demanded torque, which is torque demanded of the engine 11 out of the vehicle demanded torque Tv. The engine controller 20 executes controls such as electronic throttle control and ignition timing control so that estimated engine torque Te matches the engine demanded torque. For example, as the electronic throttle control, the engine controller 20 calculates required air intake by feedback calculation of the engine demanded torque and estimated engine torque Te, and calculates target throttle opening based on that required air intake. The engine controller 20 controls the throttle valve so that the throttle opening TA becomes the target throttle opening. For example, as the ignition timing control, the engine controller 20 calculates an ignition timing based on the rotation speed NE of the engine 11 and the required intake air volume, and controls spark plugs provided for each cylinder in a cylinder head of the engine 11 so that ignition is performed at that ignition timing.

The rotary-electric machine controller 21 has an MG demanded torque calculator 42 and a first gradual change processor 43. The MG demanded torque calculator 42 calculates demanded torque Tm1 of the rotary electric machine 13, which is torque required of the rotary electric machine 13 to achieve the vehicle demanded torque Tv by total torque of output torque of the engine 11 and output torque of the rotary electric machine 13. More specifically, the MG demanded torque calculator 42 calculates difference torque between the vehicle demanded torque Tv and the estimated engine torque Te as the demand torque Tm1 of the rotary electric machine 13. As a result, the vehicle demanded torque Tv is distributed to the demanded torque of the engine 11 and the demand torque Tm1 of the rotary electric machine 13.

The first gradual change processor 43 performs a first gradual change processing on the demanded torque Tm1 of the rotary electric machine 13 calculated by the MG demanded torque calculator 42. The first gradual change process is a process to limit a change in the rotary-electric-machine demanded torque Tm1 for a purpose of improving drivability of the hybrid vehicle 10, exhaust emissions, and fuel consumption. The detection values of each of the sensors 30 to 39 are input to the first gradual change processor 43 as setting parameters. The first gradual change processor 43 sets a variable degree of gradual change for the first gradual change processing according to driving conditions of the hybrid vehicle 10. The driving conditions of the hybrid vehicle 10 can be acquired based on the detected values of each of the sensors 30 to 39. In the present embodiment, the first gradual change processor 43 performs low-pass filter processing and change rate limiting processing as the first gradual change processing.

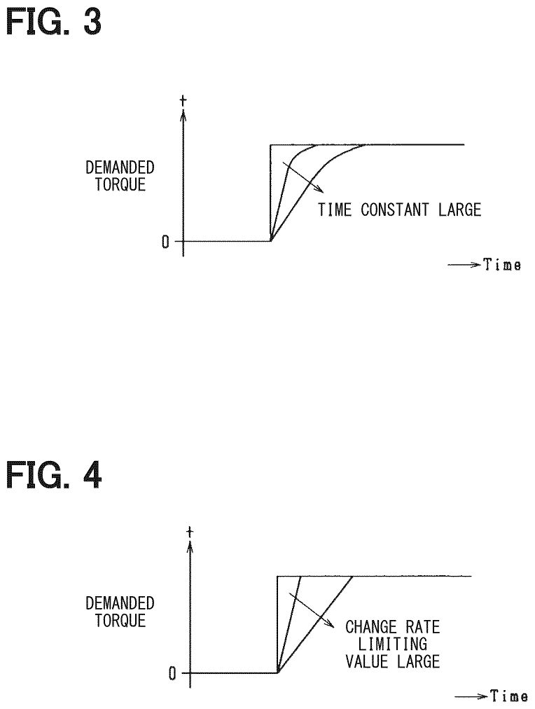

FIG. 3 shows an example of a case in which the low-pass filter processing is performed for a stepwise increasing demanded torque, and FIG. 4 shows an example of a case in which the change rate limiting processing is performed for a stepwise increasing demanded torque. In the low-pass filter processing, a change amount in the target torque per unit time gradually decreases, whereas in the change rate limiting processing, a change amount in the target torque per unit time is constant. In other words, a slope of change changes gradually in the low-pass filter processing, whereas a slope of change is constant in the change rate limiting processing. In the low-pass filter processing, the larger a filter time constant, the more limited change in the demanded torque. In the change rate limiting processing, the larger a change rate limiting value, the more limited change in the demanded torque. The first gradual change processor 43 sets the filter time constant of the low-pass filter processing and the change rate limiting value of the change rate limiting processing variably according to the driving conditions of the hybrid vehicle 10.

In addition to the first gradual change process, the first gradual change processor 43 performs correction processing of the rotary-electric-machine demanded torque Tm1. In the correction processing, an engine torque correction value ΔTc, which corresponds to a difference between the current engine load and the engine load corresponding to a highest fuel consumption point, is calculated and used to correct the rotary-electric-machine demanded torque Tm1. Along with this, the engine torque correction value ΔTc is input to the engine controller 20, and the engine torque correction value ΔTc is used to correct the engine demanded torque.

In detail, the first gradual change processor 43 acquires a current engine operating point based on map information in which the pedal operation amount Ac and the rotation speed NE of the engine 11 are pre-correlated with fuel consumption characteristics. The engine operating point is the operating point determined by the engine load calculated based on the pedal operation amount Ac and the rotation speed NE of the engine 11. The first gradual change processor 43 calculates an engine torque correction value ΔTc that corresponds to a difference between the engine load at the current engine operating point and the engine load at the highest fuel consumption point in the fuel consumption characteristics.

Instead of calculating the engine torque correction value ΔTc so that the engine operating point becomes the highest fuel consumption point, the first gradual change processor 43 may calculate an engine torque correction value ΔTc equivalent to a difference between the engine load at the present time and the engine load at a point near the highest fuel consumption point. For example, the map information of fuel efficiency characteristics defines a high fuel efficiency region as a region including the highest fuel efficiency point, and the engine torque correction value ΔTc may be calculated so that the engine operating point is within that the high fuel efficiency region.

The first gradual change processor 43 corrects the rotary-electric-machine demanded torque Tm1 based on the calculated engine torque correction value ΔTc. More specifically, the value obtained by subtracting the engine torque correction value ΔTc from the rotary-electric-machine demanded torque Tm1 is the rotary-electric-machine demanded torque Tm1 after correction. The first gradual change processor 43 outputs the calculated engine torque correction value ΔTc to the engine controller 20. The engine controller 20 corrects the engine demanded torque based on the input engine torque correction value ΔTc. More specifically, a value obtained by adding the engine torque correction value ΔTc to the engine demanded torque is the engine demanded torque after correction.

In FIG. 2, the first gradual change processor 43 calculates a rotary-electric-machine command torque Tm1_F by performing the first gradual change processing on the rotary-electric-machine demanded torque Tm1. The rotary-electric machine controller 21 controls the torque of the rotary electric machine 13 based on the rotary-electric-machine command torque Tm1_F. More specifically, the rotary-electric machine controller 21 alternately switches on the upper and lower arms of each phase of the inverter 17 based on the rotary-electric-machine demanded torque Tm1.

FIG. 5 shows a procedure of the torque control. This control is performed repeatedly by the rotary-electric machine controller 21, for example, at a predetermined control cycle.

In step S10, the rotary-electric-machine demanded torque Tm1 is calculated. In the present embodiment, the vehicle demanded torque Tv and the estimated engine torque Te are obtained from the engine controller 20, and a differential torque between the vehicle demanded torque Tv and the estimated engine torque Te is calculated as the rotary-electric-machine demanded torque Tm1.

In step S11, the filter time constant of the low-pass filter processing is set. For example, the filter time constant of the low-pass filter processing is set based on setting parameters such as the pedal operation amount Ac, the vehicle speed Vs, the shift position Sp and the driving mode signal Mo, taking an acceleration response and a deceleration response into consideration. More specifically, when the pedal operation amount Ac is the same, the filter time constant is set smaller when the vehicle speed Vs is low (for example, 30 [km/m]) than when the vehicle speed Vs is high (for example, 80 [km/h]), thereby improving acceleration/deceleration response. When the driving mode signal Mo indicating the sports mode is input, the filter time constant is set smaller than when the driving mode signal Mo indicating the economy mode or the normal mode is input, thereby improving acceleration/deceleration response.

In step S12, the change rate limiting value for the change rate limiting processing is set. For example, the change rate limiting value of the change rate limiting processing is set based on set parameters such as the pedal operation amount Ac, the vehicle speed Vs, the shift position Sp, and the gear ratio, taking torque shock during gear shifting into consideration. More specifically, when the vehicle speed Vs is gradually increasing at the same rate, the change rate limiting value is set higher when a change range of the gear ratio during gear shift is large than when the change range of the gear ratio during gear shift is small, thereby reducing the torque shock during the gear shift.

In step S13, the engine torque correction value ΔTc is calculated, which corresponds to a difference between the engine load at the current time and the engine load at the highest fuel consumption point. To calculate the current engine load, the pedal operation amount Ac detected by the accelerator sensor 30 and the rotation speed NE of the engine 11 detected by the engine rotation speed sensor 34 may be used. The engine torque correction value ΔTc, which corresponds to a difference between the engine load at the current point and the engine load at a point near the highest fuel consumption point, may be calculated.

In step S14, the rotary-electric-machine demanded torque Tm1 is corrected. In the present embodiment, a value obtained by subtracting the engine torque correction value ΔTc from the rotary-electric-machine demanded torque Tm1 is the corrected rotary-electric-machine demanded torque Tm1. At this time, the change rate limiting value of the change rate limiting processing may be changed from the value set in step S12, taking into account that the correction of the rotary-electric-machine demanded torque Tm1 has been made. The process in step S14 corresponds to a torque correction unit.

In addition to correcting the rotary-electric-machine demanded torque Tm1, the engine torque correction value ΔTc should be output to the engine controller 20. In the engine controller 20, the engine torque correction value ΔTc is added to the engine demanded torque. Therefore, the engine 11 is controlled so that the engine operating point coincides with the highest fuel consumption point.

In step S15, battery protection control is performed. The battery protection control is a control that limits the rotary-electric-machine demanded torque Tm1 for a purpose of protecting the storage battery 18. For example, an upper limit value of the rotary-electric-machine demanded torque Tm1 is limited when a temperature of the storage battery 18 is higher than a predetermined temperature. For example, the upper limit value of the rotary-electric-machine demanded torque Tm1 is limited when a terminal voltage of the storage battery 18 is lower than a predetermined voltage. In this case, the settings of the filter time constant and the change rate limiting value may be changed to take into account the limitation of the upper limit value of the rotary-electric-machine demanded torque Tm1.

The temperature and the terminal voltage of the storage battery 18 can be detected by the battery monitoring unit 38. Instead of the terminal voltage of the storage battery 18, the upper limit value of the rotary-electric-machine demanded torque Tm 1 may be limited when an SOC of the storage battery 18 is higher than a predetermined SOC. The SOC of the storage battery 18 can be calculated from the detection value of the battery monitoring unit 38.

In step S16, protection control of the rotary electric machine is performed. The protection control of the rotary electric machine is a control that limits the rotary-electric-machine demanded torque Tm1 for a purpose of reducing occurrence of overheating abnormalities in the rotary electric machine 13. For example, the upper limit value of the rotary-electric-machine demanded torque Tm1 is limited when a temperature of the rotary electric machine 13 is higher than a predetermined temperature. In this case, the settings of the filter time constant and the change rate limiting value may be changed to take into account the limitation of the upper limit value of the rotary-electric-machine demanded torque Tm1. The temperature of the rotary electric machine 13 can be determined by using a value detected by the temperature sensor 37. In the present embodiment, steps S11, S12, and S14 to S16 correspond to a setting unit.

In step S17, the rotary-electric-machine command torque Tm1_F is calculated. The rotary-electric-machine command torque Tm1_F is calculated by performing the first gradual change process on the rotary-electric-machine demanded torque Tm1. Therefore, the occurrence of the torque shock can be reduced, the acceleration/deceleration response can be improved, and the rotary electric machine 13 and the storage battery 18 can be protected during transient periods when the operating conditions of the hybrid vehicle 10 change.

One of the low-pass filter processing and the change rate limiting processing may be performed as the first gradual change process, or the low-pass filter processing and the change rate limiting processing may be performed in combination. In the present embodiment, the low-pass filter processing is performed as the first gradual change process. The filter time constant set according to steps S11, S14 to S16 is used when the low-pass filter processing is performed. The filter time constant is set within a range defined by a predetermined minimum value KT1 and a maximum value KT2. The minimum value KT1 of the filter time constant is, for example, 0 [ms] to 30 [ms], and the maximum value KT2 of the filter time constant is, for example, 200 [ms]. The change rate limiting value set by the process in steps S12, S14 to S16 is used when the change rate limiting processing is used.

By the way, as a technique for monitoring torque control of the rotary-electric machine controller 21, a monitoring torque, which is a difference between the vehicle demanded torque Tv and the estimated engine torque Te as well as the rotary-electric-machine demanded torque Tm1, is calculated, and based on a comparison result between the rotary-electric-machine command torque Tm1_F and the monitoring torque, the suitability of torque control is determined. In this case, based on a deviation between the rotary-electric-machine command torque Tm1_F and the monitoring torque, it is determined that an abnormality is occurring in the torque control. Therefore, the torque control of the rotary-electric machine controller 21 is monitored.

However, when the first gradual change process is performed on the rotary-electric-machine demanded torque Tm1 and the rotary-electric-machine command torque Tm1_F is calculated as described above, there is concern that a deviation between the rotary-electric-machine command torque Tm1_F and the differential torque may occur and an error may be judged to have occurred.

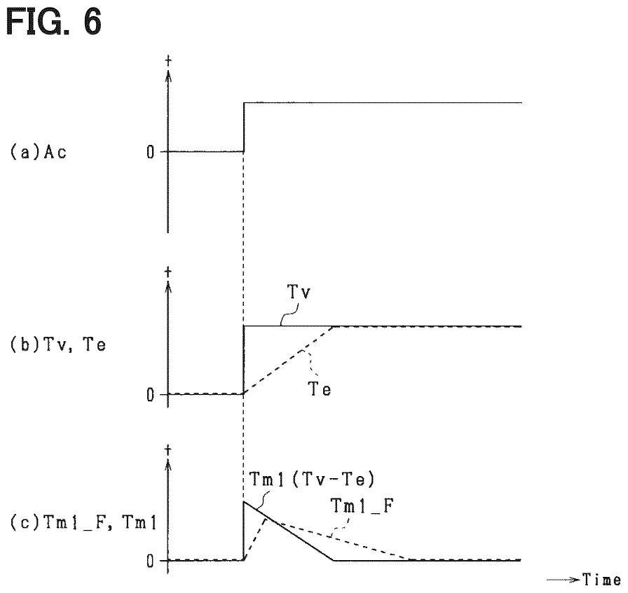

A case in which it is erroneously determined that an abnormality is occurring in the torque control is explained in detail, using FIG. 6. In FIG. 6, (a) shows a transition of the pedal operation amount Ac, (b) shows a transition of the vehicle demanded torque Tv and the estimated engine torque Te, (c) shows a transition of the rotary-electric-machine demanded torque Tm1, which corresponds to the difference torque between the vehicle demanded torque Tv and the estimated engine torque Te, and the rotary-electric-machine command torque Tm1_F.

As the vehicle demanded torque Tv increases with an increase in the pedal operation amount Ac, the output torque of the engine 11 gradually increases to achieve the vehicle demanded torque Tv. In this case, the estimated engine torque Te gradually increases. In this case, the rotary-electric-machine demanded torque Tm1 is basically a difference between the vehicle demanded torque Tv and the estimated engine torque Te. Therefore, the rotary-electric-machine demanded torque Tm1 increases in a step-like manner and then gradually decreases.

However, in order to respond to the various demands mentioned above for the torque control of the rotary electric machine 13, the first gradual change process is performed on the rotary-electric-machine demanded torque Tm1. As a result, the rotary-electric-machine command torque Tm1_F after the first gradual change process is limited in change compared to the rotary-electric-machine demanded torque Tm1.

In this case, the rotary-electric-machine demanded torque Tm1 corresponds to the monitoring torque, and the rotary-electric-machine command torque Tm1_F is higher than the rotary-electric-machine demanded torque Tm1 during a period when the rotary-electric-machine command torque Tm1_F is gradually decreasing. In other words, there is a period of time during which the rotary-electric-machine command torque Tm1_F can be considered to be too high. The occurrence of an abnormality may be erroneously determined when a deviation value between the rotary-electric-machine command torque Tm1_F and the rotary-electric-machine demanded torque Tm1 becomes large during this period.

Therefore, the following configuration is provided in the present embodiment to properly monitor the torque control.

Returning to the description in FIG. 2, the rotary-electric machine controller 21 has a monitoring torque calculator 44 and a second gradual change processor 45. The vehicle demanded torque Tv and the estimated engine torque Te are input to the monitoring torque calculator 44. The monitoring torque calculator 44 calculates a difference torque between the vehicle demanded torque Tv and the estimated engine torque Te as a monitoring torque Tm2. The monitoring torque Tm2 is input to the second gradual change processor 45.

The second gradual change processor 45 performs a second gradual change process, different from the first gradual change process, on the monitoring torque Tm2 calculated by the monitoring torque calculator 44. The second gradual change process limits a change in the monitoring torque Tm2 for a purpose of proper torque control monitoring. The second gradual change processor 45 performs the second gradual change process on the monitoring torque Tm2 and outputs the monitoring torque Tm2_F after the second gradual change process. The details of the second gradual change process are described below.

The rotary-electric machine controller 21 has a torque deviation calculator 46, an abnormality determination unit 47, and a fail-safe processor 48. The rotary-electric-machine command torque Tm1_F and the monitoring torque Tm2_F after the second gradual change process is input to the torque deviation calculator 46. The torque deviation calculator 46 calculates a torque deviation ΔTm between the rotary-electric-machine command torque Tm1_F and the monitoring torque Tm2_F after the second gradual change process. The torque deviation ΔTm is input to the abnormality determination unit 47.

The abnormality determination unit 47 determines whether the torque deviation ΔTm is greater than an abnormality determination value Ts. The abnormality determination unit 47 set an abnormality flag FM of the torque control when the abnormality determination unit 47 determines that the torque deviation ΔTm is greater than the abnormality determination value Ts. The abnormality flag FM of the torque control is a signal that, when off, indicates that the torque control is normal, and when on, indicates that an error has occurred in the torque control. The abnormality determination unit 47 outputs the torque control abnormality flag FM to the fail-safe processor 48. The fail-safe processor 48 executes fail-safe processing when the abnormality flag FM is set by the abnormality determination unit 47. In the present embodiment, the fail-safe processor 48 turns off the cutoff switch 19 as the fail-safe process. As a result, the drive of the rotary electric machine 13 is stopped.

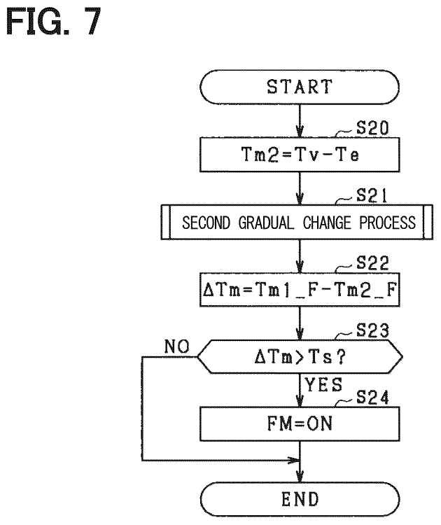

FIG. 7 shows a procedure of torque monitoring control for monitoring the torque control. The torque monitoring control is performed repeatedly by the rotary-electric machine controller 21, for example, at a predetermined control cycle.

In step S20, the monitoring torque Tm2 is calculated. The monitoring torque Tm2 is a difference torque between the vehicle demanded torque Tv and the estimated engine torque Te. In step S21, the second gradual change process is performed on the monitoring torque Tm2. As a result, the monitoring torque Tm2_F after the second gradual change process is calculated.

In step S22, the torque deviation ΔTm is calculated. The torque deviation ΔTm is a value obtained by subtracting the monitoring torque Tm2_F after the second gradual change process from the rotary-electric-machine command torque Tm1_F. In step S23, it is determined whether the torque deviation ΔTm is higher than the abnormality determination value Ts. When the torque deviation ΔTm is less than or equal to the abnormality determination value Ts, the torque monitoring control is terminated. On the other hand, when the torque deviation ΔTm is higher than the abnormality determination value Ts, go to step S24. In step S24, the torque control abnormality flag FM is set. The torque control abnormality flag FM is cleared when the torque monitoring control is initiated.

The abnormality determination value Ts should be set to a positive value. In this case, it is determined that an abnormality is occurs in the torque control based on a fact that the rotary-electric-machine command torque Tm1_F is higher than the above-mentioned monitoring torque Tm2_F after the second gradual change process, and the deviation value between those rotary-electric-machine command torque Tm1_F and monitoring torque Tm2_F is larger than the abnormality determination value Ts.

In the torque control of the rotary electric machine 13, a degree of slow change of the first gradual change process (that is, the filter time constant and the change rate limiting value) affects torque shock reduction during transients, acceleration/deceleration response, power consumption, and other factors. For example, a larger degree of the gradual change is effective in reducing the torque shock, while a smaller degree of the gradual change is effective in improving the acceleration/deceleration response. Accordingly, as explained in FIG. 5 above, the degree of gradual change of the first gradual change process is changed appropriately according to the vehicle operating conditions at each time. However, for the second gradual change process, there is no need for a complex gradual change process like the first gradual change process.

Similarly, the degree of the gradual change of the first gradual change process, the degree of the gradual change of the second gradual change process may be changed according to various conditions. However, when the degree of the gradual change of the second gradual change process is set using a non-redundant signal with low reliability, there is concern about reduced reliability in the torque control monitoring. Therefore, as explained below, the setting of the degree of the gradual change in the second gradual change process is designed to ensure reliability in the torque control monitoring while simplifying a configuration.

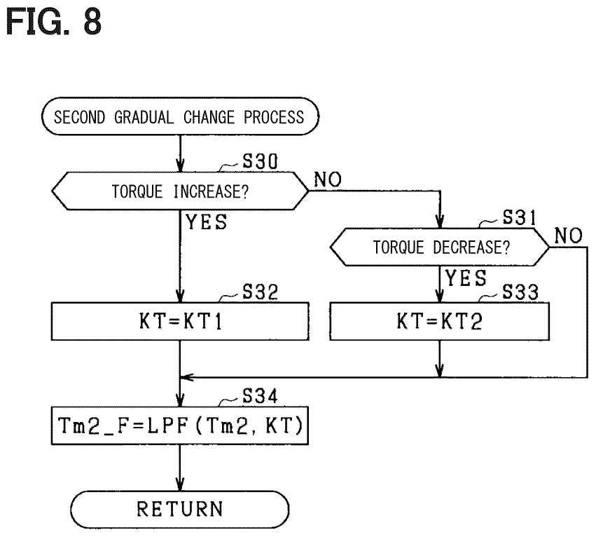

FIG. 8 shows a procedure for the second gradual change process. The second gradual change process is the process of step S21 in FIG. 7. The low-pass filter processing is performed as the second gradual change process.

In step S30, it is determined whether a situation is such that a demand for torque increase of the rotary electric machine 13 occurs. In the present embodiment, when a value obtained by subtracting the monitoring torque Tm2 in the previous control cycle from the monitoring torque Tm2 in the current control cycle (that is, the rotary-electric-machine demanded torque Tm1) is determined to be greater than an increase judgment value, it is determined to be a situation where a demand for the torque increase in the rotary electric machine 13 occurs. The increase judgment value should be set to a positive value. When a negative determination is made in step S30, the process proceeds to step S31. On the other hand, when an affirmative determination is made in step S30, the process proceeds to step S32.

In step S31, it is determined whether a situation is such that a demand for torque reduction of the rotary electric machine 13 occurs. In the present embodiment, when a value obtained by subtracting the monitoring torque Tm2 in the previous control cycle from the monitoring torque Tm2 in the current control cycle is less than a reduction judgment value, it is determined that a demand for the torque reduction of the rotary electric machine 13 occurs. The reduction judgment value may be set to a negative value. When an affirmative determination is made in step S31, the process proceeds to step S33. On the other hand, when a negative determination is made in step S31, the process proceeds to step S34. In the present embodiment, step S30, S31 corresponds to a torque demand determination unit.

The rotary-electric machine controller 21 determines that an abnormality has occurred when the rotary-electric-machine command torque Tm1_F is higher than the monitoring torque Tm2_F after the second gradual change process and when their torque deviation ΔTm is larger than the abnormality determination value Ts. As a result, abnormalities that may lead to excessive output torque of the hybrid vehicle 10, that is, excessive vehicle speed can be properly determined. In this case, when the second gradual change process limits the change in the decrease in the monitoring torque Tm2 during the torque decrease, the monitoring torque Tm2_F after the second gradual change process will be reduced to be smaller than the rotary-electric-machine command torque Tm1_F. This reduced false detection of the torque control. On the other hand, when the increase in the monitoring torque Tm2 is limited by the second gradual change process during the torque increase, the monitoring torque Tm2_F after the second gradual change process will be lower than the rotary-electric-machine command torque Tm1_F, and there is a concern that this may cause an erroneous determination of a torque abnormality. Therefore, the following steps S32 and S33 are performed in the present embodiment.

In step S32, the filter time constant KT of the low-pass filter processing in the second gradual change process is set smaller than in step S33. In the present embodiment, in step S32, the filter time constant KT is set to the minimum value KT1. In step S33, the filter time constant KT is set to the maximum value KT2. Subsequent to steps S32, S33, the process proceeds to step S34. If a negative judgment is made in step S31, the filter time constant KT should be the value set in the previous control cycle.

In step S34, the low-pass filter processing is performed on the monitoring torque Tm2 as the second gradual change process. In this case, one of the minimum value KT1 and the maximum value KT2 of the low-pass filter processing in the first gradual change process is used as the filter time constant KT of the low-pass filtering process. This sets the degree of change of the second gradual change process according to the degree of change of the first gradual change process.

When the change rate limiting processing is performed in step S34 instead of the low-pass filter processing, the change rate limiting value may be the change rate limiting value of the change rate limiting processing as the first gradual change process, and be set to the maximum value that can be set in that change rate limiting processing in step S32. In step S33, the change rate limiting value may be set to a minimum value of the change rate limiting value that can be set in the change rate limiting processing as the first gradual change process. In the present embodiment, the process in S34 corresponds to a monitoring gradual change processor.

By the way, in the hybrid vehicle 10, the rotary-electric-machine demanded torque Tm1 and monitoring torque Tm2 are calculated by a differential torque between the vehicle demanded torque Tv and the estimated engine torque Te. In this case, when a function of engine torque estimation in the engine controller 20 is abnormal, reliability of the torque monitoring can be reduced.

The engine torque correction value ΔTc corresponding to a difference between the current engine load and the engine load at the maximum fuel consumption point is calculated, and the rotary-electric-machine demanded torque Tm1 and the engine demanded torque is corrected based on the engine torque correction value ΔTc, thereby achieving high fuel efficiency operation on the engine and this allows the high fuel efficiency operation, while achieving the vehicle demanded torque Tv in a suitable manner. However, when the engine torque correction value ΔTc is excessively large, there is concern that the reliability of the torque monitoring will be reduced due to a larger correction amount of the torque demanded by the rotary-electric-machine demanded torque Tm1.

Therefore, in the present embodiment, the process for determining the reliability of the estimated engine torque Te or validity of the engine torque correction value ΔTc is performed in consideration of these points.

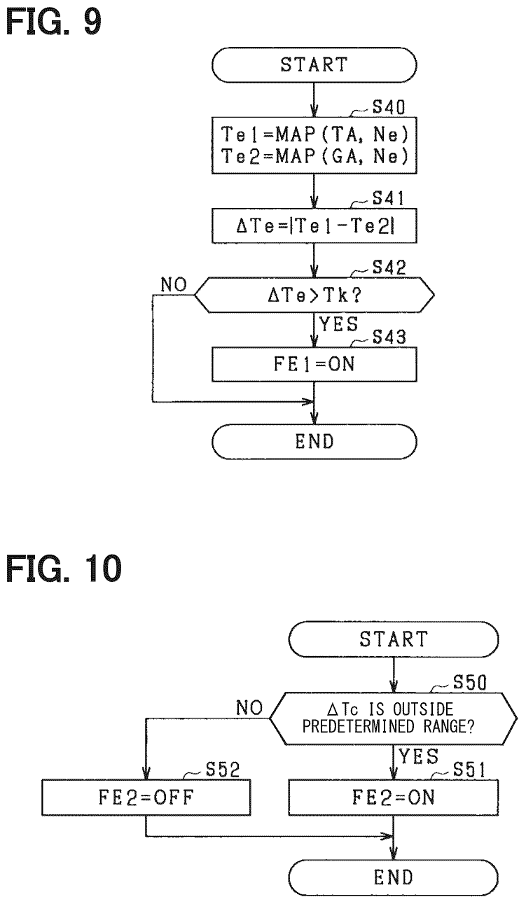

First, a process for determining the reliability of the estimated engine torque Te is explained using FIG. 9. FIG. 9 shows a procedure for determining the reliability of the estimated engine torque Te. This process is performed repeatedly by the engine controller 20, for example, in a predetermined control cycle.

In step S40, first engine torque Te1 is estimated using the throttle opening degree TA as first engine load information, and second engine torque Te2 is estimated using the intake air volume GA as second engine load information. In the present embodiment, the first engine torque Te1 is estimated based on the throttle opening degree TA and the rotation speed NE of the engine 11, using correspondence information (for example, map information or formula information) in which the engine torque, the throttle opening degree TA, and the rotation speed NE of the engine 11 are corresponded beforehand. The second engine torque Te2 is estimated based on the intake air volume GA and the rotation speed NE of the engine 11, using correspondence information (for example, map information or formula information) in which the engine torque, the intake air volume GA, and the rotation speed NE of the engine 11 are corresponded beforehand.

In step S41, differential engine torque ΔTe is calculated. The differential engine torque ΔTe is an absolute value of a difference between the first engine torque Te1 and the second engine torque Te2. In step S42, it is determined whether the differential engine torque ΔTe is greater than a reliability determination value Tk. The reliability determination value Tk should be set to a positive value. When an affirmative determination is made in step S42, an abnormality flag FE1 for the engine torque estimation is set. The abnormality flag FE1 for the engine torque estimation is a signal that indicates that the estimated engine torque Te is reliable when it is off and that the estimated engine torque Te is unreliable when it is on. On the other hand, when a negative determination is made in step S42, the process is terminated. The abnormality flag FE1 for the engine torque estimation is set to clear when the reliability determination process is started. In the present embodiment, the process of steps S40 to S42 corresponds to a reliability determination unit.

Next, a process of determining the validity of the engine torque correction value ΔTc is explained, using FIG. 10. FIG. 10 shows a procedure for determining the validity of the engine torque correction value ΔTc. This process is performed repeatedly by the rotary-electric machine controller 21, for example, in a predetermined control cycle.

In step S50, it is determined whether the engine torque correction value ΔTc is outside a predetermined range. The predetermined range is a range defined by a positive upper limit correction value and a negative lower limit correction value, and may be set, for example, according to the torque that can be output by the rotary electric machine 13. When an affirmative determination is made in step S50, the process proceeds to step S51. On the other hand, when a negative determination is made in step S50, the process proceeds to step S52. In the present embodiment, the process of step S50 corresponds to a correction torque determination unit.

In step S51, the abnormality flag FE2 for the engine torque correction value ΔTc is set. In step S52, the abnormality flag FE2 for the engine torque correction value ΔTc is cleared. The abnormality flag FE2 for the engine torque correction value ΔTc is a signal that, when is set, indicates that the engine torque correction value ΔTc is excessively large, and when is cleared, indicates that the engine torque correction value ΔTc is within an acceptable range.

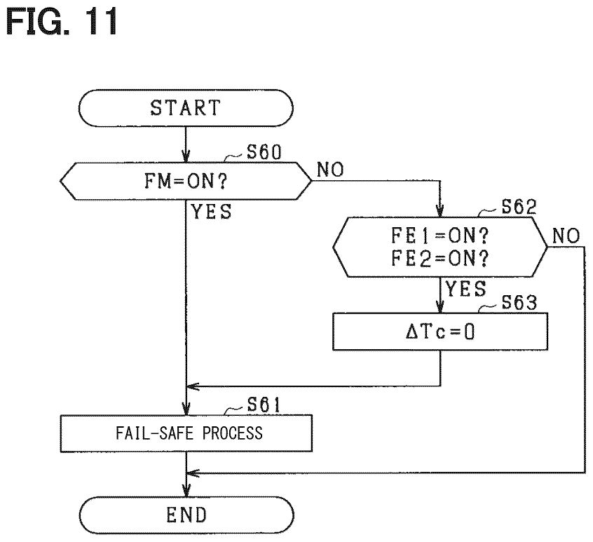

The rotary-electric machine controller 21 performs an abnormality determination control to determine whether to execute fail-safe processing based on each abnormality flag FM, FE1, and FE2. FIG. 11 shows a procedure of the abnormality determination control. This control is performed repeatedly by the rotary-electric machine controller 21, for example, at a predetermined control cycle.

In step S60, it is determined whether the abnormality flag FM for the torque control is set or not. When an affirmative determination is made in step S60, the process proceeds to step S61. When a negative determination is made in step S60, the process proceeds to step S62.

In step S61, the fail-safe processing is performed. In the present embodiment, the cutoff switch 19 is turned off as the fail-safe processing.

In step S62, it is determined whether at least one of the two flags, the abnormality flag FE1 for the engine torque estimation and the abnormality flag FE2 for the engine torque correction value ΔTc, is set. When an affirmative determination is made in step S62, the process proceeds to step S63.

In step S63, the engine torque correction value ΔTc is set to 0. As a result, the correction processing by the engine torque correction value ΔTc is stopped. Then, the process proceeds to step S61. On the other hand, when a negative determination is made in step S62, the process is terminated. In other words, in the present embodiment, when the estimated engine torque Te is determined to be reliable in step S62 and the engine torque correction value ΔTc is determined to be within the predetermined range, the torque control is monitored in the next control cycle.

The present embodiment described in detail above achieves the following effects.

For the monitoring torque Tm2, the second gradual change process, different from the first gradual change process, is performed, and the torque control is monitored based on the results of the comparison between the rotary-electric-machine command torque Tm1_F and the monitoring torque Tm2_F after the second gradual change process. As a result, the erroneous determination that torque control is abnormal under normal conditions can be reduced, and the torque control can be properly monitored.

A situation in which the demand for the torque increase or the torque decrease of the rotary electric machine 13 is determined, and when it is determined that the demand for the torque increase occurs, the filter time constant KT of the low-pass filter processing in the second gradual change process is set smaller than when it is determined that the demand for the torque decrease occurs. As a result, the erroneous determination of the torque control error can be properly reduced, regardless of whether the torque of the rotary electric machine 13 is decreasing or increasing.

In the torque control of the rotary electric machine 13, the degree of change of the first gradual change process with respect to the rotary-electric-machine demanded torque Tm1 affects the torque shock reduction during transients, the acceleration/deceleration response, the electric power consumption, and other factors. Therefore, it is desirable to change the degree of the first gradual change process according to the vehicle operating conditions at each time. However, for the second gradual change process, a complex gradual change process used for the first gradual change process is not necessary. With this in mind, the degree of change in the second gradual change process is set according to the degree of change in the first gradual change process. As a result, the degree of gradual change in each gradual change process can be combined, thereby improving the accuracy of the torque monitoring, while simplifying a configuration of the gradual change process.

More specifically, the filter time constant KT of the low-pass filter processing is set to KT2, the maximum value of the filter time constant in the low-pass filter processing as the first gradual change process, at the time of the torque reduction of the rotary electric machine 13. As a result, the occurrence of a condition in which the rotary-electric-machine command torque Tm1_F is higher than the monitoring torque Tm2_F after the second gradual change process can be reduced during the torque reduction of the rotary electric machine 13. Therefore, the occurrence of the erroneous determination in the torque monitoring is precisely reduced.

The filter time constant KT of the low-pass filter processing is set to the minimum value KT1 of the filter time constant in the low-pass filter processing as the first gradual change process, at the time of the torque increase of the rotary electric machine 13. As a result, the occurrence of a condition in which the rotary-electric-machine command torque Tm1_F becomes higher than the monitoring torque Tm2_F after the second gradual change process can be reduced at the time of the torque increase of the rotary electric machine 13. Therefore, the occurrence of the erroneous determination in the torque monitoring is precisely reduced.

The monitoring torque Tm2 is used to determine whether a demand for the torque increase or the torque decrease occurs in the rotary electric machine 13. The monitoring torque Tm2 is a value calculated based on the redundant signals: the pedal operation amount Ac, the vehicle speed Vs, the shift position Sp, the throttle opening degree TA, the intake air volume GA, and rotation speed NE of the engine 11. Therefore, the second gradual change process is performed without the use of a non-redundant signal. The degree of the change of the second gradual change process, which is preset according to the degree of the change of the first gradual change process, is selected according to the result of determining of a situation in which a demand for the torque increase or the torque decrease of the rotary electric machine 13 occurs. Therefore, the reliability in the torque control monitoring can be ensured while simplifying the configuration of the second gradual change process.

### Other Embodiments

The above embodiments may be modified as follows, for example.

The engine 11 is not limited to gasoline engines, but may be a diesel engine that uses diesel oil as fuel, or may be other engines that uses any other fuel.

Instead of the engine controller 20 calculating the vehicle demanded torque Tv, the rotary-electric machine controller 21 may calculate the vehicle demanded torque Tv. In this case, the rotary-electric machine controller 21 corresponds to an upper-level controller.

A vehicle in which a controller is installed is not limited to the hybrid vehicle 10, but may be, for example, an electric vehicle equipped with a rotary electric machine among an engine and a rotary electric machine as the driving power source. In this case, the hybrid vehicle 10 does not need to have an engine controller 20, and the detected values of each sensor 30, 31, 35, 37 and the driving mode signal Mo need only be input to the rotary-electric machine controller 21. The engine torque Te does not have to be estimated, and the rotary-electric-machine demanded torque Tm1 should be the vehicle demanded torque Tv. Accordingly, the process to determine the reliability of the estimated engine torque Te described earlier in FIG. 9 may not be performed. The process of determining the validity of the engine torque correction value ΔTc described earlier in FIG. 10 may not be performed. In the process for determining whether to perform the fail-safe processing described earlier in FIG. 11, steps S62 and S63 may not be performed.

In steps S30 to S33, setting the degree of the change of the second gradual change process according to the degree of the change of the first gradual change process is not limited to selecting one of the minimum value KT1 and the maximum value KT2 of the filter time constant of the low-pass filter processing in the first gradual change process, which are predetermined filter time constants. For example, a process may acquire the degree of the change of the first gradual change process and set the degree of the change of the second gradual change process based on the acquired degree of the change. More specifically, the degree of the change of the first gradual change process obtained is retained for a predetermined period of time, and in step S32, the minimum value of the retained degree of the change is set as the degree of the change of the second gradual change process, and in step S33, the maximum value of the retained degree of the change is set as the degree of the change of the second gradual change process. Without processing steps S30 to S33, the process of obtaining the degree of the change of the first gradual change process may be performed each time, and the process of changing the degree of change of the second gradual change process to the acquired degree of change of the first gradual change process may also be performed each time. According to the present embodiment, the degree of the change in the first and second gradual change processes can be precisely matched.

The process of determining the reliability of the estimated engine torque Te may be performed by the rotary-electric machine controller 21 instead of the engine controller 20. The process of determining the validity of the engine torque correction value ΔTc may be performed by the engine controller 20 instead of the rotary-electric machine controller 21.

A mobile object on which the controller is mounted is not limited to a vehicle, and may be, for example, an aircraft or a ship.

The controller and the technique according to the present disclosure may be achieved by a dedicated computer provided by constituting a processor and a memory programmed to execute one or more functions embodied by a computer program. Alternatively, the controller and the technique according to the present disclosure may be achieved by a dedicated computer provided by constituting a processor with one or more dedicated hardware logic circuits. Alternatively, the controller and the technique according to the present disclosure may be achieved using one or more dedicated computers constituted by a combination of the processor and the memory programmed to execute one or more functions and the processor with one or more hardware logic circuits. The computer program may be stored in a computer-readable non-transitory tangible storage medium as an instruction executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A controller applied to a moving object movable using a rotary electric machine as a power source, wherein
the controller is configured to:
calculate demanded torque of the rotary electric machine based on operation information indicating operation status of the moving object;
calculate command torque of the rotary electric machine by performing a first gradual change process on the demanded torque of the rotary electric machine to limit a change in the demanded torque; and
perform torque control of the rotary electric machine, the controller comprising:
a monitoring torque calculator configured to calculate monitoring torque of the rotary electric machine based on the operation information;
a monitoring gradual change processor configured to perform a second gradual change process, which is different from the first gradual change process, on the monitoring torque;
a monitoring unit configured to compare the command torque of the rotary electric machine with the monitoring torque after performing the second gradual change process and monitor the torque control of the rotary electric machine based on the result of the comparison; and,
a torque demand determination unit configured to determine whether a demand for torque increase or a demand for torque decrease of the rotary electric machine occurs,
the monitoring unit is configured to determine that an abnormality occurs in the torque control based on a fact that the command torque is greater than the monitoring torque after performing the second gradual change process and a discrepancy value between the command torque and the monitoring torque is greater than a threshold value, and
the monitoring gradual change processor is configured to reduce the degree of change in the second gradual change process in a case of determination that the demand for torque increase occurs further than a case of determination that the demand for torque decrease occurs.

2. The controller according to claim 1, further comprising
a setting unit configured to variably set degree of change in the first gradual change process according to the operating condition of the moving object, wherein
the degree of change in the second gradual change process is set according to the degree of change in the first gradual change process.

3. The controller according to claim 1, further comprising
a setting unit configured to variably set degree of change in the first gradual change process according to the operating condition of the moving object, wherein
the degree of change in the second gradual change process is set to a maximum value of the degree of change in the first gradual change process in the case of determination that the demand for torque decrease of the rotary electric machine occurs.

4. The controller according to claim 1, further comprising
a setting unit configured to variably set degree of change in the first gradual change process according to the operating condition of the moving object, wherein
the degree of change in the second gradual change process is set to a minimum value of the degree of change in the first gradual change process in the case of determination that the demand for torque increase of the rotary electric machine occurs.

5. A controller applied to a moving object movable using a rotary electric machine as a power source, wherein
the controller is configured to:
calculate demanded torque of the rotary electric machine based on operation information indicating operation status of the moving object;
calculate command torque of the rotary electric machine by performing a first gradual change process on the demanded torque of the rotary electric machine to limit a change in the demanded torque; and
perform torque control of the rotary electric machine, the controller comprising:
a monitoring torque calculator configured to calculate monitoring torque of the rotary electric machine based on the operation information;
a monitoring gradual change processor configured to perform a second gradual change process, which is different from the first gradual change process, on the monitoring torque; and
a monitoring unit configured to compare the command torque of the rotary electric machine with the monitoring torque after performing the second gradual change process and monitor the torque control of the rotary electric machine based on the result of the comparison,
the moving object is a hybrid vehicle equipped with an engine and the rotary electric machine as a driving power source,
the demanded torque of the rotary electric machine is a difference torque between vehicle demanded torque calculated based on the operation information and estimated engine torque calculated based on engine information including engine load information,
the monitoring torque calculator is configured to calculate the difference torque between the vehicle demanded torque and the estimated engine torque as the monitoring torque,
the controller further comprising a reliability determination unit configured to:
estimate first engine torque using first load information as the engine load information;
estimate second engine torque using second load information, which is different from the first load information, as the engine load information; and
determine reliability of the estimated engine torque based on degree of deviation between the first engine torque and the second engine torque, wherein
the monitoring unit is configured to monitor the torque control of the rotary electric machine based on determination that the reliability of the estimated engine torque is high by the reliability determination unit.

6. A controller applied to a moving object movable using a rotary electric machine as a power source, wherein
the controller is configured to:
calculate demanded torque of the rotary electric machine based on operation information indicating operation status of the moving object;
calculate command torque of the rotary electric machine by performing a first gradual change process on the demanded torque of the rotary electric machine to limit a change in the demanded torque; and
perform torque control of the rotary electric machine, the controller comprising:
a monitoring torque calculator configured to calculate monitoring torque of the rotary electric machine based on the operation information;
a monitoring gradual change processor configured to perform a second gradual change process, which is different from the first gradual change process, on the monitoring torque; and
a monitoring unit configured to compare the command torque of the rotary electric machine with the monitoring torque after performing the second gradual change process and monitor the torque control of the rotary electric machine based on the result of the comparison,
the moving object is a hybrid vehicle equipped with an engine and the rotary electric machine as a driving power source,
the demanded torque of the rotary electric machine is a difference torque between vehicle demanded torque calculated based on operation information and estimated engine torque calculated based on engine information including engine load information,
the monitoring torque calculator is configured to calculate, as the monitoring torque, the difference torque between the vehicle demanded torque calculated based on the operation information and the estimated engine torque,
the controller further comprising:
a torque correction unit configured to:
calculate an engine torque correction value corresponding to a difference between current engine load and engine load in a predetermined high fuel efficiency region including a highest fuel efficiency point; and
correct the command torque of the rotary electric machine based on the engine torque correction value; and
a correction torque determination unit configured to determine whether the engine torque correction value is within a predetermined range, and
the monitoring unit is configured to monitor the torque control of the rotary electric machine based on determination that the engine torque correction value is within the predetermined range.
